(19) United States
(12) Patent Application Publication
(10) Pub. No.: US 2006/0148461 A1
(43) Pub. Date: Jul. 6, 2006

(54) Method of carrying out call forwarding realized in dual-mode mobile phone

(75) Inventors: Cheng-Shing Lai, Taipei (TW); Qiang Fan, Nankng (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/175,143

(22) Filed: Jul. 7, 2005

(30) Foreign Application Priority Data
Dec. 31, 2004 (TW) 093141841

(51) Int. Cl. H04M 3/42

(52) U.S. Cl. 455/417

(57) ABSTRACT

The present invention is to provide a method of carrying out call forwarding realized in a dual-mode mobile phone having setting options including a setting of a specific incoming call and a setting of a specific call forwarding target number, which comprises the steps of receiving an incoming call by the mobile phone from a mobile communication system (such as GSM); determining whether the phone number of the incoming call matches the target number; and if yes, using a specific call forwarding setting software installed therein to automatically transfer the incoming call to a low power communication system (such as PHS), enabling a user to receive a desired incoming call in low power communication system for free.

### FIELD OF THE INVENTION

The present invention relates to a dual-mode mobile phone, more particularly to a dual-mode mobile phone having setting options including a setting of a specific incoming call and a setting of a specific call forwarding target number, allowing a user to enable the option and set incoming calls to be transferred out of GSM to a low power PHS and enabling the user to receive a desired incoming call in PHS for free.

### BACKGROUND OF THE INVENTION

This is a knowledge and information explosion era. Communications and information exchange among people are more often. Network (e.g., the Internet) era has come. Also, mobile communications and wireless communications have known a rapid, spectacular development in recent years. A wireless communication tool (e.g., cellular phone) as modern communication means has become a ubiquitous tool for both personal and work related tasks throughout the world.

The fast development of electronics industry (e.g., cellular phone manufacturing) causes cellular phones to be closely associated with our daily life and work. GSM (Global System for Mobile Communications) based cellular phones are very popular. However, GSM based cellular phones may emit electromagnetic emission at a level to pose a health risk. Further, a telephone company may propose discount programs about call receiving to GSM based cellular phone users. These projects about some call receiving may be free or charged to receive and some may be with a lower or higher charge.

Recently, PHS (Personal Handy-phone System) mobile phones (i.e., so-called wireless urban telephones) are available. PHS is a low power communication system. Basically, PHS substantially has similar features as GSM. The differences therebetween, i.e., the characteristics of PHS are that signal is transmitted from CS (cell station) to CS as a PHS mobile phone user moves around, the coverage of CS is small and the movement of PHS mobile phone is slow. Thus, PHS mobile phone is particularly suitable to urban people. Its fee is inexpensive but its coverage is limited. PHS mobile phones have advantages such as lower emission level and call receiving for free, etc. Thus, PHS mobile phones really bring a lot of convenience to their users.

Basically, GSM and PHS have their respective advantages. Neither GSM nor PHS can fulfill the needs of all people. As such, there are dual-mode (GSM/PHS) mobile phones commercially available. For a dual-mode mobile phone, it can operate in accordance with either GSM or PHS depending on conditions.

A dual-mode mobile phone claims to have advantages of both GSM and PHS. However, this is not true for a call received by a dual-mode mobile phone in practice. As stated above, telephone companies may provide discount rates or for free about call receiving to cellular phone users. In response, preferably, a dual-mode mobile phone is able to automatically determine the nature of an incoming call so as to transfer the call either to GSM if the call is free or to PHS or any telephone system being free about call receiving if a fee (either high or low) is required based on result of the determination. As a result, the purpose of decreasing the amount of telephone bill can be achieved. Unfortunately, existing dual-mode mobile phones cannot achieve the goal. In fact, they just transfer a received call in a typical way.

It is understood that distinguished features are key for a cellular phone manufacturer to win over other competitive manufacturers. Thus, it is desirable among cellular phone manufacturer to provide a dual-mode mobile phone capable of automatically determining the nature of an incoming call so as to transfer the call either to GSM if the call is free or to PHS being free about call receiving if a fee (either high or low) is required based on result of the determination. It is believed that dual-mode mobile phones having the above feature can increase sales by attracting more consumers. Also, the purpose of decreasing fee associated with mobile communication can be achieved.

### SUMMARY OF THE INVENTION

After considerable research and experimentation, a method of carrying out call forwarding realized in a dual-mode mobile phone according to the present invention has been devised so as to overcome the above drawback of the prior art. The drawback is that the prior dual-mode mobile phone is not able to determine the nature of an incoming call for automatically transferring it to one mobile communication system having a lower fee or for free about receiving (i.e., for the purpose of decreasing fee associated with mobile communication) in response to the fact that telephone companies propose discount programs about call receiving to GSM based cellular phone users. By utilizing this method, the purpose of decreasing the amount of phone bill can be achieved and the chance of a user exposing to harmful electromagnetic fields when receiving calls from GSM is decreased significantly.

It is an object of the present invention to solve the problem of a user cannot use a prior dual-mode mobile phone to determine the nature of an incoming call for automatically transferring it to one mobile communication system having a lower fee or for free each call receiving for the purpose of decreasing fee associated with mobile communication in response to the fact that telephone companies launch discount programs about call receiving to cellular phone users. A method of the present invention comprises setting an option of setting a specific call forwarding in a dual-mode mobile phone; enabling the option; enabling a specific call forwarding setting software installed in the dual-mode mobile phone; receiving an incoming call from GSM by the dual-mode mobile phone; determining whether the phone number of the incoming call matches the same number as that of the specific call forwarding; and if the determination is positive, using the specific call forwarding setting software to automatically transfer the incoming call from the mobile communication system to a low power communication system for connecting the incoming call.

It is another object of the present invention to provide a number of advantages by performing the method of the present invention. These advantages comprise:

(1) It is possible of automatically transferring an incoming call from GSM to PHS for being received by configuring the dual-mode mobile phone to comprise an installed specific call forwarding setting software and set an option.

(2) By utilizing this method of the present invention only one setting is sufficient. No further setting is required thereafter if there is no change. Thus, operation is made easy.

(3) The chance of a user exposing to harmful electromagnetic fields when receiving calls from GSM is decreased significantly and the purpose of decreasing fee associated with mobile communication can be achieved.

The above and other objects, features and advantages of the present invention will become apparent from the following detailed description taken with the accompanying drawings.

### BRIEF DESCRIPTION OF THE DRAWINGS

FIG. 1 is a flow chart illustrating a process of setting an option of setting a specific call forwarding by a dual-mode mobile phone according to the invention; and

FIG. 2 is a flow chart illustrating a process of processing an incoming call in GSM by a dual-mode mobile phone when the above option has been set and enabled according to the invention.

### DETAILED DESCRIPTION OF THE PREFERRED EMBODIMENTS

The invention is directed to a method of carrying out call forwarding realized in a dual-mode mobile phone. The method comprises setting an option of setting a specific call forwarding in the dual-mode mobile phone; enabling the option; enabling a specific call forwarding setting software installed in the dual-mode mobile phone; receiving an incoming call from a mobile communication system by the dual-mode mobile phone; determining whether the phone number of the incoming call matches the same number as that of the specific call forwarding; and if the determination is positive, using the specific call forwarding setting software to automatically transfer the incoming call from the mobile communication system to a low power communication system for connecting said incoming call freely. By utilizing this method, a user can receive a desired incoming call in PHS for free. Further, the chance of a user exposing to harmful electromagnetic fields is decreased significantly. Furthermore, the purpose of decreasing fee associated with mobile communication can be achieved.

In the method of the invention the dual-mode mobile phone comprises a GSM module, a PHS module, and an installed specific call forwarding setting software. For the setting option in the dual-mode mobile phone, it allows a user to enable or disable the option and set incoming calls to be transferred out of GSM. In a case of the option enabled by the user, the phone number of the incoming call matching the same number as one of the set incoming calls to be transferred out of GSM, run the specific call forwarding setting software to automatically transfer the incoming call from GSM to PHS for being received freely.

In the method of the invention the settings of incoming calls to be transferred out of GSM is determined according to a rule that which incoming calls are free to be received in GSM and which incoming calls are charged with a fee (either low or high) and thus are to be automatically transferred from GSM to PHS for being received freely.

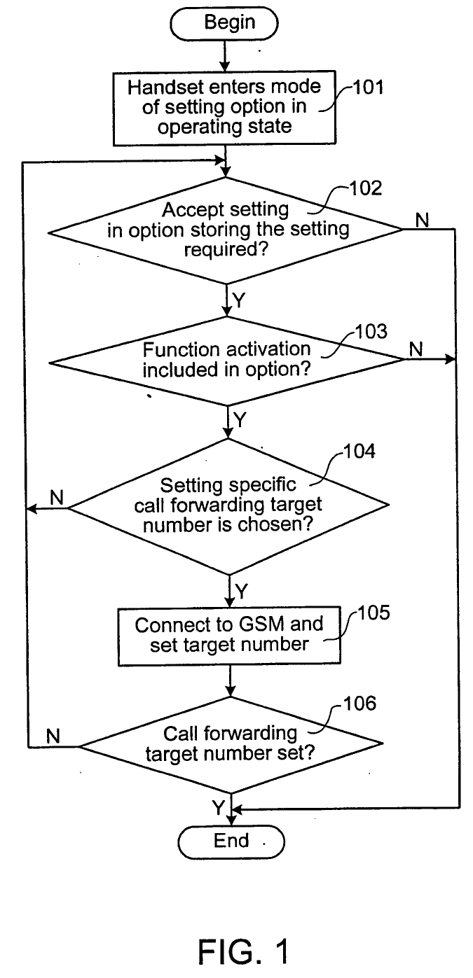

Referring to FIG. 1, there is illustrating a process of setting an option of setting a specific call forwarding by a dual-mode mobile phone according to the invention. The process comprises the following steps:

Step 101: The mobile phone enters into a mode of setting an option of setting a specific call forwarding in an operating state.

Step 102: Accepting the settings in the options including a function activation, a setting of a specific incoming call, and a setting of a specific call forwarding target number. Also, it is determined whether saving the settings is required or not. If yes, the process goes to step 103. Otherwise, a typical processing routine is performed and the process ends accordingly.

Step 103: Determining whether the function activation is chosen in the option or not. If yes, the process goes to step 104. Otherwise, a typical processing routine is performed and the process ends accordingly.

Step 104: It is determined whether the settings of a specific call forwarding target number are chosen in the option or not. If yes, the process goes to step 105. Otherwise, the process loops back to step 102.

Step 105: Connecting to GSM and setting the target number for forwarding the specific call.

Step 106: It is determined whether the call forwarding target number has been set or not. If yes, the option setting process ends and thus the process ends accordingly. Otherwise, the process loops back to step 102.

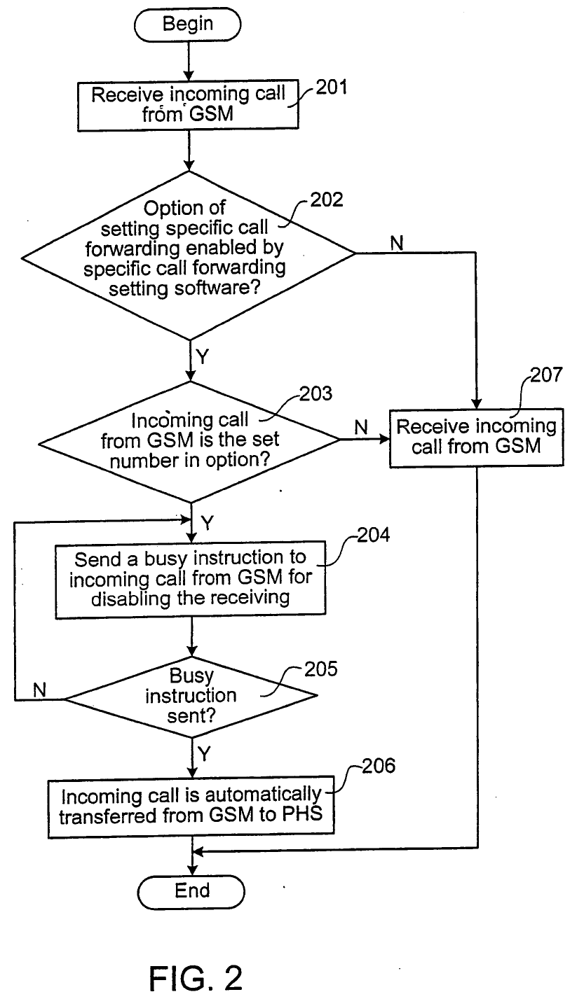

Referring to FIG. 2, it illustrates a process of processing a received incoming call from GSM by a dual-mode mobile phone when the above options have been chosen. The process comprises the following steps:

Step 201: An incoming call from GSM is received.

Step 202: It is determined by using a specific call forwarding setting software whether the option of setting a specific call forwarding target number has been chosen or not. If yes, the process goes step 203. Otherwise, the process jumps to step 207.

Step 203: It is determined whether the phone number of the incoming call matches that set in the option of setting the specific call forwarding. If yes, the process goes to step 204. Otherwise, the process jumps to step 207.

Step 204: Send a busy instruction to the mobile communication system for not connecting the incoming call from GSM. The busy instruction means a called party is busy in doing other tasks or is unable to connect the incoming call.

Step 205: It is determined whether the busy instruction has been successfully enforced or not. If yes, the process goes to step 206. Otherwise, the process loops back to step 204.

Step 206: the incoming call is automatically transferred from the mobile communication system (GSM) to a low power communication system (PHS) for connecting the incoming call. The process ends accordingly.

Step 207: The dual-mode mobile phone performs the step of connecting the incoming call from GSM in a typical way. The process ends accordingly.

While the invention herein disclosed has been described by means of specific embodiments, numerous modifications and variations could be made thereto by those skilled in the art without departing from the scope and spirit of the invention set forth in the claims.

What is claimed is:

1. A method of carrying out call forwarding realized in a dual-mode mobile phone having an option of setting a specific call forwarding therein, which enables the dual-mode mobile phone to perform the method comprising the following steps when the option is chosen:
receiving an incoming call from a mobile communication system by the dual-mode mobile phone; and
determining whether the phone number of the incoming call matches that set in the option of setting the specific call forwarding; if the determination is positive, using a specific call forwarding setting software installed therein to automatically transfer the incoming call from the mobile communication system to a low power communication system for connecting said incoming call.

2. The method of claim 1, wherein the option of setting a specific call forwarding comprises the steps of:
entering into an operating stage for the option;
accepting the settings in the option including a function activation, a setting of a specific incoming call, and a setting of a specific call forwarding target number;
in response to a positive determination that saving the settings is required and the function activation is enabled, determining whether the setting of a specific call forwarding target number is chosen in the option;
in response to another positive determination that the setting of a specific call forwarding target number is chosen, connecting to the mobile communication system and setting the target number; and
in response to still another positive determination that the call forwarding target number has been set, finishing the setting of a specific call forwarding.

3. The method of claim 2, wherein in response to a negative determination of the setting of a specific call forwarding target number is not included in the option, and returns to the option of setting a specific call forwarding.

4. The method of claim 2, wherein in response to setting a specific call forwarding, the dual-mode mobile phone performs the steps of:
receiving an incoming call from the mobile communication system;
using the specific call forwarding setting software to determine whether the phone number of the incoming call matches that set in the option of setting the specific call forwarding;
in response to a positive determination that the phone number of the incoming call from the mobile communication system matches that set in the option of setting the specific call forwarding, sending a busy instruction to the mobile communication system for not connecting said incoming call;
determining whether the busy instruction has been successfully enforced; and
in response to a positive determination that the busy instruction has been successfully enforced, automatically transferring the incoming call from the mobile communication system to a low power communication system for connecting said incoming call.

5. The method of claim 4, wherein in response to a negative determination, by using the specific call forwarding setting software, that the option of setting a specific call forwarding target number has not been chosen, the dual-mode mobile phone performs the step of connecting the incoming call from the mobile communication system.

6. The method of claim 4, wherein in response to a negative determination that the phone number of the incoming call from the mobile communication system doesn't match that set in the option of setting the specific call forwarding, the dual-mode mobile phone performs the step of connecting the incoming call from the mobile communication system.

7. The method of claim 4, wherein the mobile communication system is GSM.

8. The method of claim 4, wherein the low power communication system is PHS.
